(19) United States
(12) Patent Application Publication
(10) Pub. No.: US 2017/0302322 A1
(43) Pub. Date: Oct. 19, 2017

(54) UNIVERSAL ROTATING AND LOCKING TABLET CASE

(71) Applicant: Aaron M. Harris, Pittsburgh, PA (US)

(72) Inventor: Aaron M. Harris, Pittsburgh, PA (US)

(21) Appl. No.: 15/488,126

(22) Filed: Apr. 14, 2017

Related U.S. Application Data
(60) Provisional application No. 62/322,761, filed on Apr. 14, 2016.

(51) Int. Cl. H04B 1/3877; F16M 11/02

(52) U.S. Cl. CPC H04B 1/3877; F16M 11/02

(57) ABSTRACT

A rotatable case for holding an electronic device during video conferencing or gaming. The case includes a device-surrounding frame, a main body component with a lower planar surface, a rotatable bottom, an upper surface, one or connecting sidewalls and a groove in which an axially tilting rod can be locked in place. That rod includes spaced fingers for holding the framed device and preventing it from being accidentally pulled down, knocked over or removed from its locking fingers. The case also includes means for securing the main body component to a planar surface.

### CROSS-REFERENCE TO RELATED APPLICATION

This is a perfection of U.S. Provisional Application Ser. No. 62/322,761, filed on Apr. 14, 2016, the disclosure of which is fully incorporated by reference herein.

### BACKGROUND OF THE INVENTION

### 1. Field of the Invention

Babies and toddlers play and interact in their natural environment on the floor. If you give a baby (that can sit) or toddler (that can crawl or walk) a video chat device (touch phone or tablet) they will often do one of two things: 1) touch/hit the screen repeatedly causing the video chat app device to freeze, fail or quit altogether; or 2) throw the device. This normally results in the baby/toddler, caregiver and person on the other end of the video chat being annoyed, frustrated, and disappointed. It can also result in damage or destruction to the video chat device, or the baby/toddler getting hurt.

### 2. Relevant Art

There are numerous device holders worth noting. They include (in chronological order):

Doherty et al U.S. Pat. No. 6,856,506 shows a three-dimensional docking support for a tablet or other related computing device.

Japanese Patent No. 2006-174,620 shows a digital camera base.

Yu U.S. Pat. No. 7,130,186 shows a rotatable screen on a portable electronic device.

Lev et al U.S. Pat. No. 7,345,871 shows a locking interface for a tablet computer display.

Keely et al. U.S. Pat. No. 7,350,011 shows a mobile device expansion system with a related support stand.

Motoe et al U.S. Pat. No. 7,778,018 shows an angled support stand with a built in connector.

Takizawa U.S. Pat. No. 7,800,896 shows a connecting device for detachably holding an electronic apparatus. It includes a support that is rotatable for portrait or landscape usage.

DeCamp et al U.S. Published Application No. 20120024918 includes multiple device holder alternatives at least one of which includes device holding “fingers”.

Daigle et al U.S. Published Application No. 20120068043 shows a tablet holder with a cover-mounted handle.

Olukotun et al. U.S. Published Application No. 20120097831 shows a sleeve system and stand for rectangular electronic display devices.

Dai U.S. Published Application No. 20120131826 shows a support stand with a swivel pedestal and suction cup component.

Gallouzi et al. U.S. Published Application No. 20120170212 discloses a T-shaped tablet computer stand.

Fan U.S. Pat. No. 8,282,060 shows an auxiliary fastening apparatus for tablets and other like electronic devices.

Yang et al. U.S. Pat. No. 8,424,830 shows a simplistic, foldable tablet holder.

Aldana et al. U.S. Published Application No. 20140072312 discloses a base-like dock for portable electronic devices.

Cho U.S. Pat. No. 8,706,175 shows a phone and tablet stand with a rotatable mounting head.

Gallagher et al. U.S. Pat. No. 8,783,458 shows a case accessory for electronic devices, said accessory having a base and a rotatable rear-device support.

Lui et al. U.S. Design Patent No. D711,366 shows a mobile phone/tablet stand with a suction disc base.

Funk et al. U.S. Pat. No. 9,163,779 shows a tablet mounting stand that retains a tablet with compression.

Finally, Negretti U.S. Pat. No. 9,211,001 shows a holder for a phone that can be used in either a vertical or horizontal position.

### SUMMARY OF THE INVENTION

This product allows babies and toddlers from 0-3 years old (or at the point of development the child understands proper usage) to video chat (Skype®, Facetime®, etc.) without their parents, guardians, caregiver having to constantly hold (actually securely lock about or onto) the device or worry about the session being interrupted by the child touching the screen. It will also allow various vendors, boutique stores and the like, to have a securely held sales tool (a tablet or the like) on a countertop for customers to view from numerous angles (floor level, standing, etc.). It will also enable small to medium corporations to facilitate video meetings with parties not on site by holding the electronic device securely while still allowing for its preferred tilt and/or axial rotation from a firmly held location.

Parents, especially new parents, want to show off their latest addition(s) in an easy, yet safe (for both the child and the device) manner. The only way for them currently do to this is to hold the video chat device. This product allows a parent to safely encase, i.e. lock in, the device and then mount it in a safe, tilt-able, rotatable holder at baby/toddler level so that everyone can more see what's on the viewing screen of the device. Parents also want their child to more fully interact with: the party with whom they are video chatting on the device; and/or the educational game/app installed on that device, without stopping the application(s) or harming themselves. This invention lets a child get close to the electronic device and touch, swat or even hit it without disrupting the session or harming the device and/or child.

In the corporate environment, this product allows parties not at the same site, or in the same city, state or country as another call participant to better, more seamlessly communicate with each other when video conferencing. The device can have its viewing (i.e. tilt) angle adjusted and its 360° viewing range manually or mechanically rotated depending on where the primary sound source at the meeting emanates.

This invention discloses a case for holding an electronic device during video conferencing or gaming. That case comprises: a frame for holding the electronic device from at least two adjacent sides, a main body component with a rotatable base, a lower planar surface, an upper surface, one or connecting sidewalls and a groove in which an axially tilting rod is situated, said rod including spaced fingers for firmly locking onto the framed device to prevent it from being accidentally pulled down, knocked over and/or prematurely pulled out of its designated holder. The case further includes means for securing the main body component to a planar surface.

### SUMMARY OF THE DRAWINGS

Pictures from the provisional, original FIGS. 1 through 7, do not represent a final solution for requirements. Rather, they were provided to merely help understand certain preferred features of the invention. Original FIG. 8 was an overview showing an encased electronic device being held by a first embodiment.

FIGS. 9 through 15 address a second generation variation/embodiment.

More particularly:

FIG. 1 is a top perspective view of a first embodiment/variation locking base according to this invention;

FIG. 2 is a top perspective view looking axially along the device holding channel of the locking base from FIG. 1;

FIG. 3 is a side plan view along the axial device holding channel of FIGS. 1 and 2;

FIG. 4 is a top perspective view of a second embodiment of locking base according to this invention;

FIG. 5 is a side plan view along the axial device holding channel of FIG. 4;

FIG. 6 is a side perspective view of a device held in its case per one embodiment of this invention;

FIG. 7 is a front axial view of the device and case from FIG. 6;

FIG. 8 is a front perspective view of a device, in its fully assembled case, locked in an upright position per a third embodiment of the invention;

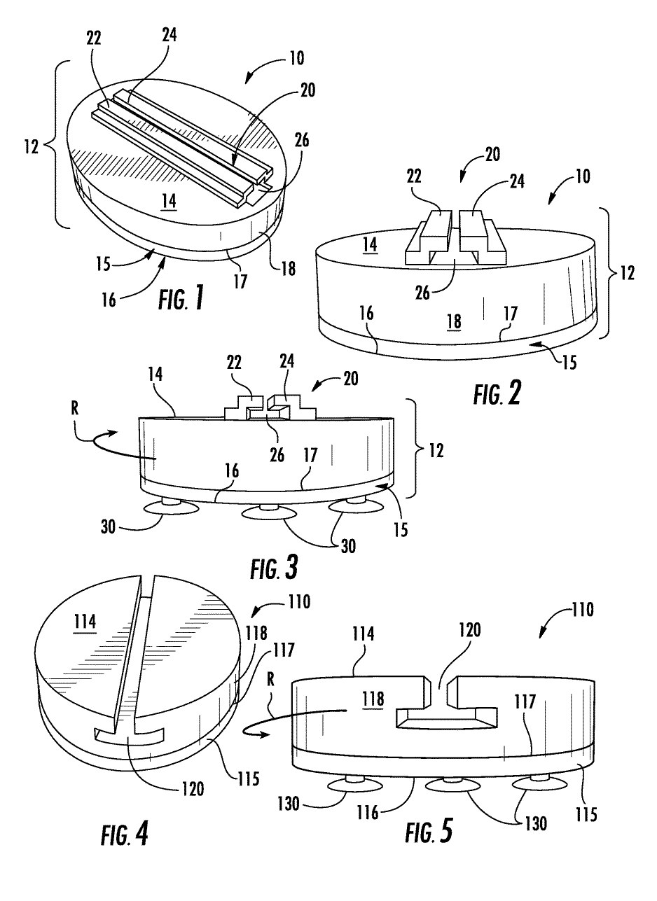

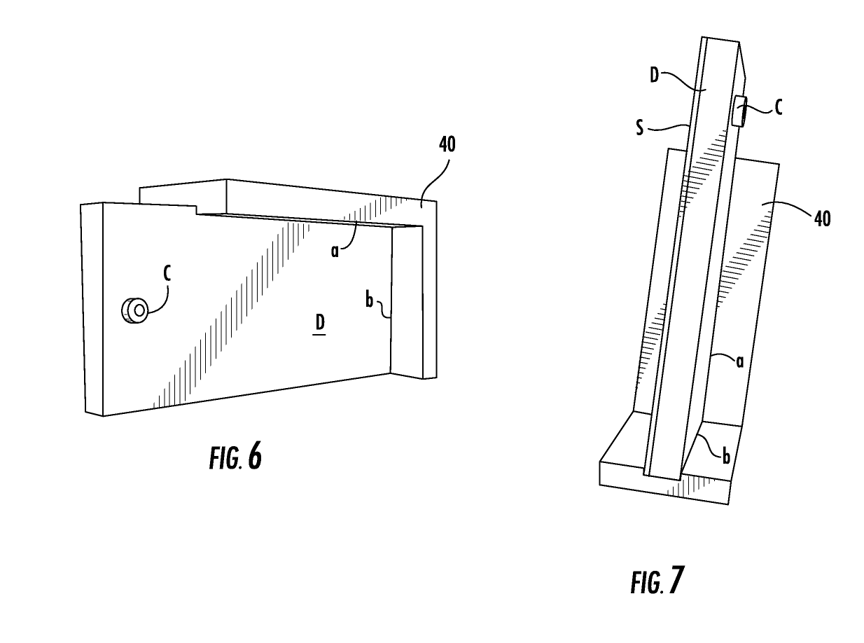

FIG. 9 is a top perspective view of a fourth embodiment (fully assembled), with a tablet in a fully surrounding case held between a pair of width-adjustable, rotatable fingers;

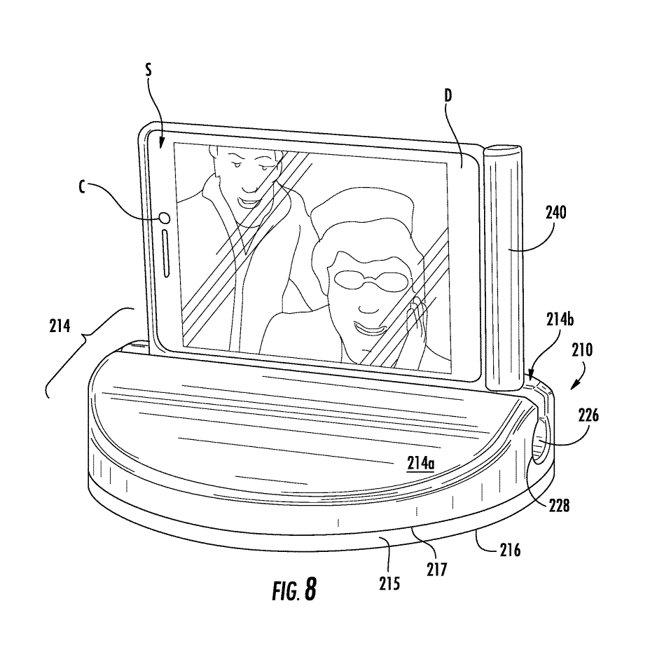

FIG. 10 is an exploded close up view of circled region X in FIG. 9;

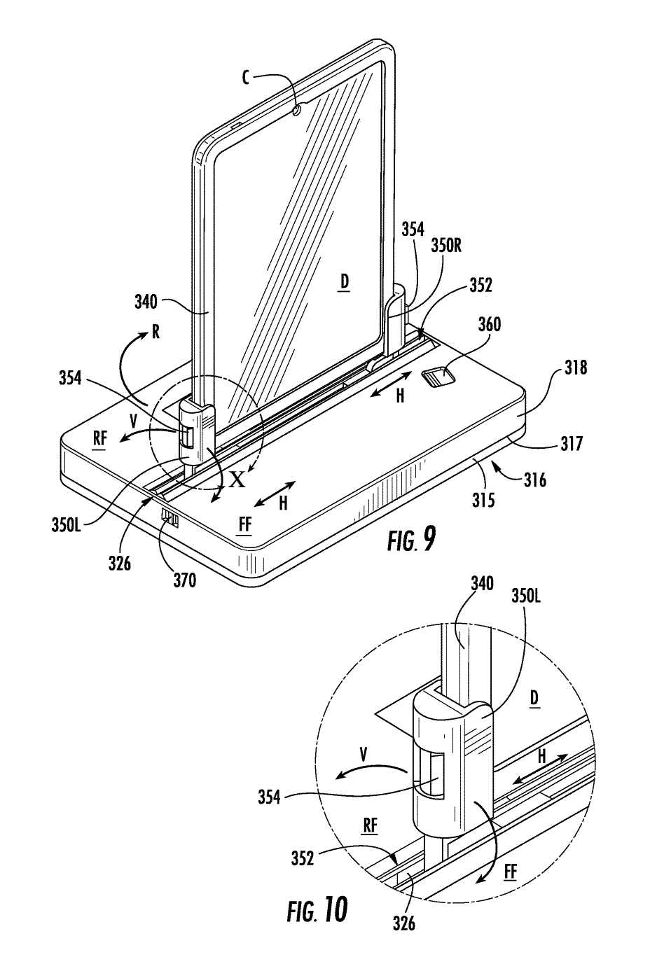

FIG. 11 is a top perspective view of the locking base (with device and holding case removed), showing its device holding fingers brought closer together and rotated downwardly for storage in a recess in the base;

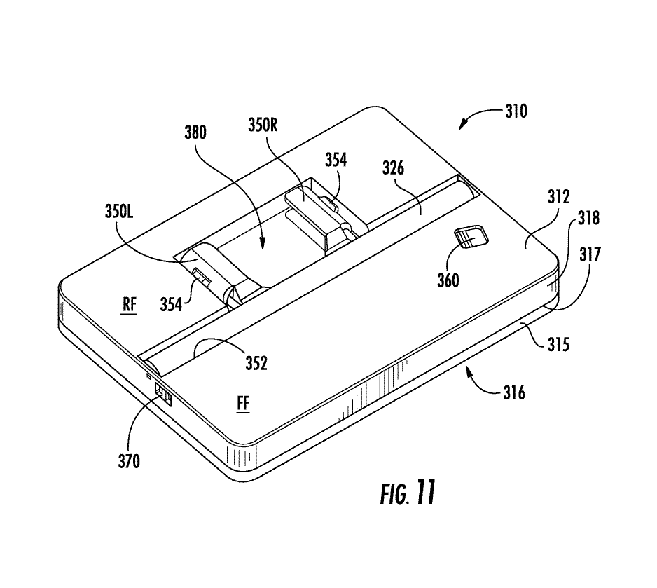

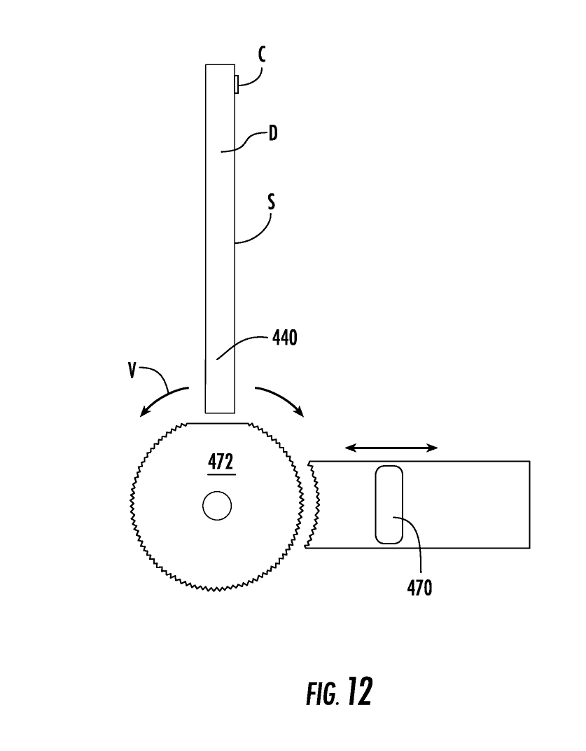

FIG. 12 is a side view diagram showing a representative tilting gear mechanism per a fifth embodiment of this invention;

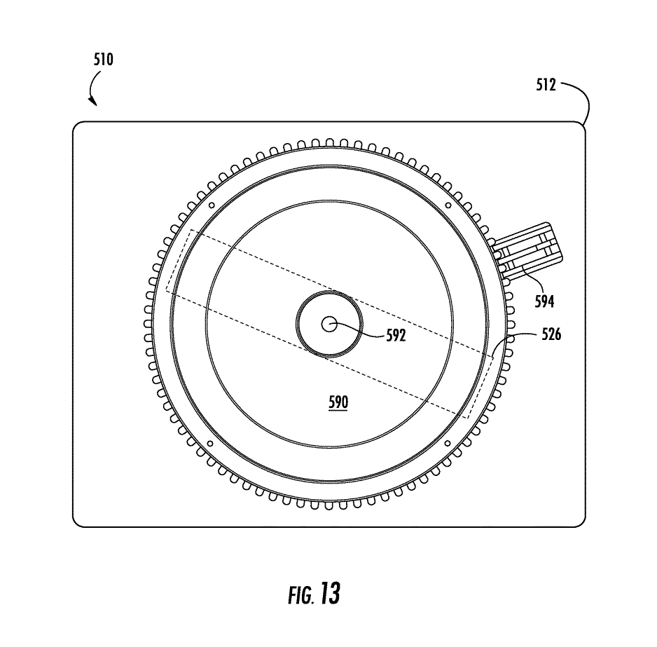

FIG. 13 is a top plan view of a rotating, locking turntable for a sixth embodiment, encased in a rectangular (square) base with its axial rotation rod depicted in dashed lines therein;

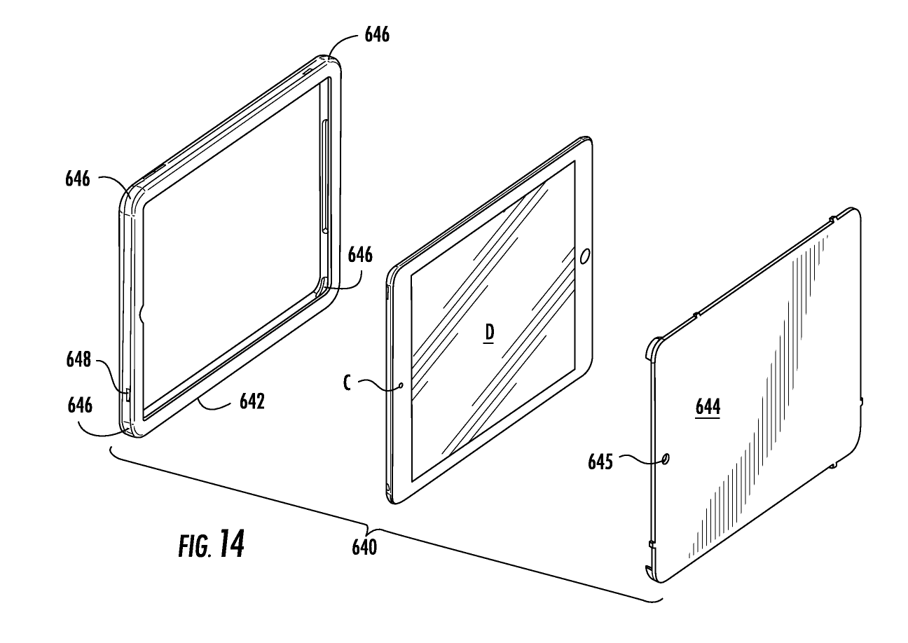

FIG. 14 is an exploded sectional perspective showing front and rear surrounds for a tablet device per yet another embodiment of this invention and

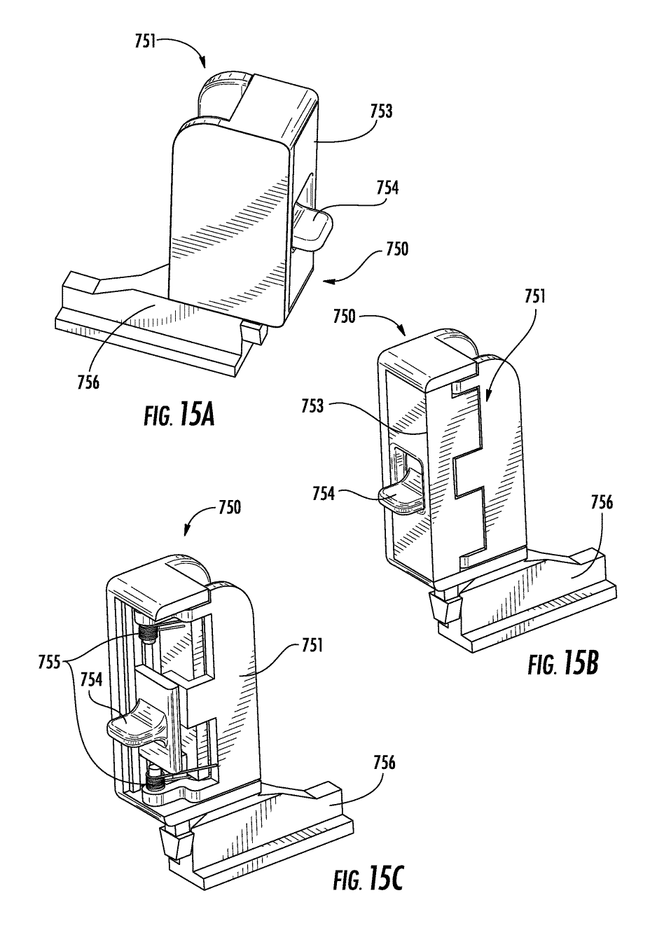

FIGS. 15A through C are perspective views of an alternative embodiment of locking finger arrangement for accommodating different thicknesses of electronic devices.

### DESCRIPTION OF PREFERRED EMBODIMENTS

Preferably, a plastic, wrap-around case surrounds a peripheral edge to a tablet or other electronic device. That fully edge-protected device is then installed in and supported by a separate holder component. In a first variation, that holder component is oval, round or rectangular but with rounded corners so as to not provide any sharp edges. The encased device can install into the aforesaid holder component in either a portrait or landscape orientation. It can easily detach therefrom for consumer storage or vendor packaging/merchandising.

A first embodiment of this holder base may be rotated a full 360 degrees, similarly to that of a “lazy Susan”. In some views, that “axial” rotation is indicated with arrow R. Such rotation allows the encased device to rotate thereabout at the same time. The holder base includes a locking button so that the customer/user may choose to have the device locked in one preferred position on a tabletop or no longer be subjected to further axial rotation positioning.

The tablet (or other electronic device) may also have its relative viewing angle adjusted after being encased and inserted into the aforementioned holder base. A user should be able to grab the top of his/her encased device (after inserting into the holder base), then either pull it towards them or push it away from them to adjust the angle for best viewing. At a minimum, this rotation should allow for automatic stopping points at 75 degrees, 60 degrees and 45 degrees relative to perpendicular (on either side of the 90 degree preferred insertion angle). A user of this holder can push the top of its encased device away from him/her, tilting it towards a rear face RF of the base so that everyone sitting about a common tabletop can easily see the party on the other side of a video-conferencing call. Alternately, the holder can be pulled forward, i.e. towards the front face FF of its base should the supervising parent to a Skype® session be sitting in a chair with the holder at a table's edge while the baby or toddler crawls about at floor level.

The holder base will come with some means for easily mounting to a flat surface (whether that is a table top or floor made from tile, hardwood or carpet). A strong suction device similar to what is used to mount kitchen/restaurant tools like an apple peeler/corer to the counter is prudent for most surfaces. A drop-down plurality of strong magnetic legs may be provided in a first alternative variation. For a carpeted surface, the holder base may be provided with claw-like gripper fingers and/or hook-and-eye (i.e., Velcro®) variations. For an outside (on the ground) application, the device can be fitted with descending safety “spikes”.

Prototype testing device and initial targeted devices to support Will start with Apple® iPad 2, Mini and Air (i.e., the largest usage share of Apple tablet products). When demand increases, will expand to other Apple devices and to numerous non-Apple products (tablets, phones, etc.). The prototype external case design (the holder base will be the same for all devices) should be built for an Apple iPad 2 encasement (for height, length and width) since that product has the top usage share of Apple tablet products. Such dimensions should accommodate about 99% of today's market of tablets and and cell phones. Ideally, though, the wrap-around case, and most definitely the under supporting holder-base, should work with most all tablets without issue making it even more “universal”.

Case/Base Separation

1. For business owner applications, the holder base should be a separate item from the device surrounding case to optimize price and use utility for customers. They should only have to purchase the cases they want to use for a given electronic device, rather than buying a new/different base and case each time they own a different (sized) device.

2. As a business owner, customer/user, retail buyer and retail visual merchandiser, a separately packaged and sold holder base, from the device encasement unit, will be simpler and less bulky for manufacture, storing, marketing, shelving in stores and/or shipping.

3. As a retail buyer and merchandiser, separately sold holder bases and cases will allow for more units to easily fit on a shelf or hanger and accommodate greater varieties/quantities of product/models in the same display area or hanger.

4. As a customer/user, the separation of case from holder base would allow for easier packing and storage when not in use.

Case and Base

1. As a customer/user, the case should be made to slide easily yet snugly into the holder base but then lock into place thereafter so that it doesn't move while in use. And only when desired, should that case be able to easily unlock from its holder base for intentional removal, separation and storage as desired.

2. As a customer/user, the holder base of this invention should be able to accommodate different sizes/shapes of electronic devices (from cell or smart phones to tablets to smaller computer screens). They may have varying lengths (but the same widths or thicknesses). The holder base of this invention should be able to accept, and readily lock into place, encased cases with different horizontal lengths. These bases should also easily allow for a user to change the orientation of the device being held, i.e., from portrait to landscape, and then back to portrait the next time, so that regardless of device installation therein, the holder base will easily adapt and yet firmly lock it in place so as to NOT move—particularly from side-to-side, or be able to be prematurely pulled out of its holder.

3. As a customer/user, at least one face side of this case should be clear/transparent so that the child may see the person with whom he/she is video chatting. Optionally, if used for the elderly and/or visually impaired, this clear face may be provided with certain degrees of purposeful magnification.

4. If not transparent, this case must include an appropriately sized and positioned hole for accommodating the camera for the electronic device being used with the invention.

5. Preferably, one edge of this case should be left “open” so that the tablet (or other device) may be readily slid into it for protection, but be sufficiently secured therein so as to preclude it from being easily slid out once it has been first locked into place.

Optionally, as a customer, it would be desirous for this device encasement to include a slotted access point so that volume levels can be controlled (i.e., changed up OR down, or even muted when necessary) while the device remains within its case. With an appropriately situated aperture in the case, the device would not have to be removed just to change the volume DURING a video chat session.

Also, as a customer/consumer, it would be desirous (even preferred) if the clear face to the device encasement is provided with a glare blocker so that the user (the parent and/or child) has no issues seeing the person with whom they are video chatting whether the device is being used in the sun, the shade, possibly even on an outside table or the front lawn.

Base Fixation/Rotation

1. As a customer, the holder base platform should be fixed so that the entirety (case and holder) will not topple, tip or otherwise fall over so as to not disrupt the flow of activities/conversation during any given video chat session.

2. As a customer, it is preferred that the holder base allow for a full 360 degrees of rotation (while still holding the device therein). That would allow a user/child to better interact with the other video chat participants. Such variable rotation my be accomplished by the parents moving the base about a vertical axis . . . or, in next generation variations, be coupled with a sound activated rotational motor so as to follow the speakers around a common usage table (especially in a work environment setting).

3. While allowing for full 360 degree rotation, this same holder base should be able to be easily, yet securely locked in place so as to NOT rotate about when no such axial rotation is wanted. Of course, for the next use of this same product, the holder base can be readily un-locked for rotating on its next application.

Other

1. Needless to say, all product materials must be 100% proven safe for humans to interact with (touch, breathe near, possibly even lick). That would keep the user/customers safe, avoid manufacturing lawsuits, and yet be fully exploitable from a parental marketing perspective as well.

2. As an owner/manufacture, the preferred choice of materials for both case AND holder base should be strong enough to withstand the pull from a 0-3 year old repeatedly yanking on its uppermost device display sitting in the appropriate encasement, then being held IN PLACE in the grooves of, between the rotating spreadable fingers of, the holder base (swivel axis). That material optimization should keep the operator/child safe while helping manufacturer/marketers avoid lawsuits and un-desirous warranty replacements.

### Advantages/Preferences

Outcome 1: ability for each user to choose whether they want their tablet (or other e-device) to be installed to its holder base in landscape OR portrait orientation; and further, to provide that holder base with an ability to be used with a multitude of device dimensions even down to the size of a standard smart or cell phone.

Outcome 2: ability for each user to LOCK his/her tablet or other mobile device between rotatable, width spreadable fingers to prevent that device from moving about (side-to-side) during use AND an ability to unlock that same device for removal from the invention when no longer needed (with the end of a given video chat session, for example).

Outcome 3: a) an ability for user to determine/choose preferred (tilt or) viewing angles of the device within the holder base; and b) an ability of that user to lock in that selected viewing angle thereby preventing front-to-rear rotational movement of the device within its holder case thus preventing an accidental (perhaps, even by actions of the child) movement to a different, second (less desired) viewing angle.

Outcome 4: a) an ability for the user to rotate the device within its holder base a full 360°; AND b) an ability to lock that same holder base in place, if so desired, so as to prevent its rotation to another vertical/axial viewing position.

Outcome 5: ability for each user to safely store the device holding fingers into the body proper of the holder base when not in use and/or for transit

Outcome 6: ability to prevent younger users from touching/altering preferred device screen settings (including volume controls) during usage.

### Specific Design Features of the Product

1. A universal tablet case will allow most brands and sizes of tablets/e-devices to be encased for purposes of connecting to the rotating holder base. See, especially FIGS. 6 through 8.

2. A universal tablet encasement, or case, should have a mechanism on at least two sides, that allows for it to readily connect and disconnect to the rotating holder base in either a portrait or landscape orientation (See, FIGS. 6 and 7).

3. Provide the holder/base with a mechanism that allows for most every size of tablet to connect and disconnect therefrom for a truly universal end use of applications. See, FIGS. 1 through 5 and 8.

4. A universal tablet case should have a mechanism which, when connected to its partnering rotating holder/base, allows an older (as in NOT the baby or toddler) user to purposefully adjust the rotational viewing angle of the tablet screen by pulling on the top of the case—towards them, or pushing that case top partially away from them. See new FIGS. 9 through 11.

5. Mechanism within the rotating base that allows user enable or disable rotation. See the locking slides in various FIGS.

When referring to the accompanying FIGS., note that component elements common to both the various embodiments are commonly numbered though in the next hundred series. In FIGS. 1 through 3, there is shown a first embodiment of universal tablet holder (generally 10) consisting of a main base unit 12 that, in this particular version, is oval in shape. It is to be understood, however that main base unit may be alternately circular in shape and/or rectangular (with rounded corners) so as to prevent causing any injuries to babies and/or toddlers fiddling with the device while video chatting with “grandma” and the like.

The main base unit 12 has an upper surface 14, rotatable base 15, lower surface 16 and a division between the two main base sections indicated by line 17. Main base unit 12 further includes at least one lateral edge, in this case a continuously curved side 18. At about the midway diameter point to upper surface 14, there is located a receptor region 20 for an electronic device case (not shown in this view). For this particular embodiment, case receptor region 20 consists of a pair of spaced protuberances 22, 24, both being “Z-shaped” in cross-section, but which when combined with one another define a case receptor groove 26. Within that groove 26, a device case can be inserted and then slid along horizontally to rest within the main base unit 12 of tablet holder 10.

To the underside of lower surface 16, there is seen (particularly in FIG. 3) a plurality of high holding capacity, suction cups 30 for serving as mounting means to secure tablet holder 10 to a flat surface such as ceramic tile, a wooden floor or a tabletop. Alternate variations would include as securing means, one or more descending magnet legs, claws for attaching to carpet and/or soft plastic spikes for holding to a grassy lawn.

FIGS. 4 and 5 address a second variation of tablet holder 110 in which the upper surface 114 to main base unit 112 has a T-shaped, case receptor region 120 with its groove 126 being below the upper surface 114 rather than extending at least partially above that upper surface 114 (as was the case for the first embodiment at FIGS. 1 through 3). It further includes a rotatable bottom section 115, lower surface 116 and dividing line 117 along with a series of lower base suction mounts 130.

FIGS. 6 and 7 show, in two distinct views, a first version of case frame 40 with grooves for holding electronic device D (with its camera C) from along at least two perimeter edges a, b. That arrangement should also include a screen protector S for preventing a baby or toddler from accidentally disconnecting from a video conference call or closing an app or other gaming program.

When only two of four perimeter edges of device D are being secured, the two edges extend perpendicular to one another since it is not practical to secure a phone, tablet, etc. in a holder case using just two parallel sides of the device. If a device holder were to extend about 3 of the four lateral sides, at least one of the two pairs of parallel sides would be duly encased. FIG. 8 shows a third variation of tablet holder 210 with upwardly sloping plateaus 214a, 214b forming the upper surface 214 to its main base unit 212. A rotatable bottom 215, lower surface 216 and separating line 217 are also included therewith. Similar to the second embodiment at FIGS. 4 and 5, this main base unit 212 is provided with its own groove 226 (this time with rounded internal edges 228) through which an L-shaped case frame 240 for holding device D can be fed and held permanently upright, i.e., at a 90 degree angle relative to lower surface 216. Note that while the device D has a visual image depicted thereon, the camera C to that unit is not obscured by its case frame 240 in any capacity.

FIGS. 9 through 11 show a fourth embodiment of tablet case holder 310 this time exhibiting a rectangular-shaped, main base unit 312. A tablet-like device D, within surrounding case frame 340 is positioned between horizontally movable (or laterally extendible) device fingers 350 that rest in an axially rotatable track 352 within the groove 326 in upper surface 314 of main base unit 312. Upper surface 314 is separated from its rotatable compartment 315 (with its own lower surface 316) via dividing line 317.

Through internal gearing (not seen), the two fingers 350L and 350R are preferably meant to spread apart (i.e., move in or out, in the direction of arrow H) in a coordinated manner, their relative movement being made possible by engaging with respective finger lock buttons 352. For example, when left finger 350L is slid about a half inch to the right for holding a smaller device, right finger 350R would move inwardly (or to the left, in this instance) a similar half-inch distance. When the proper distancing of fingers 350L and R has been achieved about its device-surrounding case frame 340, buttons 352 can be switched over to a fully locking position.

Axial rotation of the holder in the direction of arrow R can be controlled by first unlocking rotational button 360 on the right forward face FF of main base unit 312 and spinning the whole unit (and device) about. When the desired axial location has been reached, rotational button 360 can be switched back locking everything back into place.

A second set of arrows V in FIGS. 9 and 10 show the ability of this embodiment of tablet case holder to further vary its viewing angle, or tilt. As first seen in FIG. 9, the relative position of the device D to main base unit 312 is perpendicular, or at a ninety degree angle. When tilt locking button 370 is pressed in, the gears inside groove 326 will unlock allowing for a forward or rearward tilting of device D while it is being held between fingers 350L and 350R.

There may be two distinct systems of gear rotation via locking button 370. The first would allow for pre-set's at tilt angles (either forward OR back of 90 degrees) at more common viewing angles at 75 degrees, 60 degrees and 45 degrees, respectively. Alternately, the gearing may be prearranged with no presets so that most any angle between 30 and 90 degrees may be rotationally achieved and then locked into place by pressing tilt button 370 once more, or by shifting it in an alternate direction.

FIG. 11 focuses on another preferred aspect of this fourth variation of tablet case holder 310. Particularly, with the device and its holding case removed, the device holding fingers 350L and R can be brought closer towards one another, leaving a gap of several inches between), then purposefully rotated 90 degrees towards the rear face RF of main base unit 312. There, the two “flipped down” fingers can be rested in a purposefully sized recess 380 to better protect these fingers: (a) when not in use; and/or (b) when storing or transporting the device holder to another location.

FIG. 12 is a diagram representing one gearing means for the tilting component of this holder. That gearing means includes a central cog gear 472 that, with horizontal movement of locking button 470, enable a full or partial directional tilt of surrounding case frame 440 to device D. Note, the side fingers for holding frame 440 to device D have been removed for better illustration purposes.

FIG. 13 shows another preferred aspect for holder 510, namely its ability to effect a full 360° axial rotation. That can be accomplished with a fully encased gear 590 stored within a properly sized main base unit (in this case, a square-shaped base 512 with rounded corners). That gear 590 can be spun completely about its central axis point 592 so as to allow the case holder in rod 526 (shown by dashed lines) to likewise rotate about. Should rotation not be desired at all, or should a desired angle at one's desk/work station be acceptable, further axial rotation of this variation can be stopped by engaging rotational lock 594 found at roughly 2 o'clock in the diagram of FIG. 13.

In future variations, it is anticipated that the preceding rotational gear can be coupled to voice activation mechanisms such that when placed in the center of a small business table, the display of the device can be rapidly rotated about for better focusing on the primary sound source (or main speaker) of several individuals sitting about for a particular “roundtable” discussion.

FIG. 14 shows in a segmented view, another alternative case frame 640 made up of a rear peripheral surrounding element 642 and clear front face component 644 sandwiching the device D in that view. Note, surrounding element 642 can be made of an elastic compound, with no backing plate and slightly hardened, protective corners 646 for slipping onto and about a full device D with little effort. It is critical that the camera C of that device D not be obstructed by any portion of the case frame 640 in any of the foregoing variations. Accordingly, front face component 644 is provided with its own aperture 645 for camera C.

It is also preferred that case frame 640 include an aperture or slot 648 so that volume control for the device can be fully accessed while being held between the fingers of this embodiment . . . during a video chat on that device.

In still other improvements, the preceding front face component 644 can be provided with an anti-glare coating for better viewing under sunny conditions (inside or possibly even outside).

In accompanying FIGS. 15A through C, another variation of device finger, generally 750, is shown: from a right front perspective (FIG. 15A); a reverse perspective view (FIG. 15B) showing its pivotable wall component 751; and the same view from FIG. 15B but with outer casing 753 removed. In these views, activation lever 754 can be manipulated up or down (as compared to the side-to-side lever movement in FIG. 9) for activating a spring 755 nearer the base end 756 of finger 750. When lever 754 is slid up, wall component 751 can be pivoted wider or “more open” so that this variable finger design may clamp onto (or about) a different width (or thicknesses) of electronic device for holding between adjacent finger pairs (only one finger shown).

Having described the presently preferred embodiments, it is to be understood that this invention may be otherwise embodied by the scope of the following claims.

What is claimed is:

1. A rotatable case for holding a tablet or other electronic device during video conferencing or gaming, said rotatable case comprising:
a. a frame for holding the tablet or other electronic device from at least two adjacent sides of the tablet or other electronic device;
b. a main body component having a lower planar surface, an upper surface, a rotatable base and one or connecting sidewalls between the lower planar surface and the upper surface, said main body component having a groove into which the holding frame is slidably engaged for preventing the tablet or other electric device from being accidentally knocked over or pulled down; and
c. means for securing the main body component to a substantially planar surface.

2. The rotatable holding case of claim 1 wherein the groove in the main body component extends at least partially above the upper surface of the main body component.

3. The rotatable holding case of claim 1 wherein the groove in the main body component extends beneath and into the upper surface of the main body component.

4. The rotatable holding case of claim 1 wherein the securing means includes a plurality of suction cups from the lower planar surface of the main body component.

5. The rotatable holding case of claim 1 wherein the securing means includes at least one of: a retractable magnet, a carpet gripping claw and a plurality of lawn spikes.

6. A rotatable case for holding an electronic device during video conferencing or gaming, said case comprising:
a. a frame for holding the electronic device from about a perimeter edge of the electronic device;
b. a main body component having a lower planar surface, an upper surface, a rotatable base, one or connecting sidewalls between the lower planar surface and the upper surface and a groove in which an axially tilting rod is situated, said rod including a pair of spaced fingers for holding the framed electronic device from opposed sides to prevent the held framed electronic from being pulled down, accidentally knocked over or removed prematurely therefrom; and
c. means for securing the main body component to a substantially planar surface.

7. The rotatable electronic device holding case of claim 6 wherein the pair of spaced fingers can be spaced along the rod to different widths and to different thicknesses depending on the electronic device to be held between said pair of spaced fingers.

8. The rotatable electronic device holding case of claim 6 wherein the main body component further includes: a button for controlling how far apart the pair of fingers may be spread or spaced apart along the rod.

9. The rotatable electronic device holding case of claim 6 wherein the main body component further includes: a recess in the upper surface for the pair of fingers to be moved toward one another and rotated on the rod and into the recess for storage when not in use.

10. The rotatable electronic device holding case of claim 6 wherein the rod includes an axial gear for allowing manual rotation of the electronic device towards or away from the upper surface of the main body component.

11. The rotatable electronic device holding case of claim 10 wherein axial gear allows for manual rotation of the electronic device at any variable angle relative to the upper surface of the main body component.

12. The rotatable electronic device holding case of claim 10 wherein the axial gear allows for manual rotation of the electronic device at one or more preset angles relative to the upper surface of the main body component, said preset angles selected from the group consisting of 45 degrees, 60 degrees, 75 degrees and 90 degrees relative to the upper surface of the main body component.

13. The rotatable electronic device holding case of claim 10 wherein the axial gear allows for manual rotation of the electronic device at one or more preset angles relative to the upper surface of the main body component, said preset angles selected from the group consisting of 90 degrees, 105 degrees, 120 degrees and 135 degrees relative to the upper surface of the main body component.

14. The rotatable electronic device holding case of claim 6 wherein the electronic device is selected from the group consisting of: a tablet, a laptop and a cell phone.

15. The rotatable electronic device holding case of claim 6 wherein the frame includes a full device edge surround and a clear front cover.

16. The rotatable electronic device holding case of claim 15 wherein the full device edge surround includes an aperture for allowing manual volume control of the electronic device while in the holding case.

17. The electronic device holding case of claim 15 wherein the clear front cover includes an anti-glare coating.

18. The rotatable electronic device holding case of claim 6 wherein the securing means includes at least one member selected from the group consisting of: a plurality of suction cups from the lower planar surface of the main body component; a retractable magnet, a carpet gripping claw and a plurality of lawn spikes.

19. The rotatable electronic device holding case of claim 6 wherein the main body component further includes a button for locking the rotatable base from rotating at any point about a central axis.

20. A rotating and locking case for holding an electronic tablet or cell phone while video conferencing or gaming with a baby or toddler, said case comprising:
a. a frame for surrounding a perimeter of the electronic tablet or cell phone and protecting a face of the electronic tablet or cell phone with a clear front cover;
b. a main body component having a lower planar surface, an upper surface, a rotatable base, one or connecting sidewalls between the lower planar surface and the upper surface and a groove in which an axially tilting rod is situated, said rod including a pair of spaced fingers for holding the surrounding frame at opposed sides of the electronic tablet or cell phone to prevent the electronic tablet or cell phone from being pulled down or pushed over; and
c. means for securing the main body component to a substantially planar surface.
